(19) United States
(12) Patent Application Publication
(10) Pub. No.: US 2007/0280252 A1
(43) Pub. Date: Dec. 6, 2007

(54) SYSTEM AND METHOD OF REALIZING VOICE OVER INTERNET PROTOCOL BY MEANS OF DIGITAL ENHANCED CORDLESS TELECOMMUNICATION

(75) Inventor: Chih-Hsin Chuang, Taipei City (TW)

Correspondence Address: WORKMAN NYDEGGER, 60 EAST SOUTH TEMPLE, 1000 EAGLE GATE TOWER, SALT LAKE CITY, UT, 84111, US

(73) Assignee: INVENTEC MULTIMEDIA & TELECOM CORPORATION, Taipei City (TW)

(21) Appl. No.: 11/422,018

(22) Filed: Jun. 2, 2006

(51) Int. Cl. H04L 12/56

(52) U.S. Cl. 370/395.2

(57) ABSTRACT

A system and method for realizing a Voice Over Internet Protocol (VOIP) by using the Digital Enhanced Cordless Telecommunication (DECT), wherein the Voice Over Internet Protocol is realized through Digital Enhanced Cordless Telecommunication, and a seamless handoff between intradomain and interdomain, and roamings in intradomain and interdomain are achieved through mobile agents. In order to achieve the above-mentioned objective, Digital Enhanced Cordless Telecommunication is utilized to register with a session initiation protocol (SIP) proxy. When Digital Enhanced Cordless Telecommunication is on-line for communication, the calling signals or the real-time transport protocol (RTP) data packets are processed through the mobile agents and are then transmitted. In making the intra-domain roamings, the mobile agent is used to redirect the signals directly; while making the inter-domain roamings, the signals are processed by the mobile agent through a tunnel between the mobile agents.

### BACKGROUND

1. Field of Invention

The invention relates to a system and method of a network phone, and in particular to a system and method of realizing a Voice Over Internet Protocol (VOIP) by means of a Digital Enhanced Cordless Telecommunication (DECT).

2. Related Art

In the conventional telecommunication industry, the Public Switched Telephone Network (PSTN) has been widely utilized. With the rapid progress of technology in recent years, the utilization of the mobile phone has outpaced that of the wired phone, mainly due to its mobility. In general, in business enterprises or households, the replacement of the traditional phone with the Voice Over Internet Protocol (VOIP) has become an inevitable trend. Presently, the Desktop IP Phone and Voice Gateway are the mainstays of the network phone product. However, they still have to make use of the network lines. In this respect, the mobile phone is taken as an example. If the network phone has to be popularized, the wireless network phone is an inevitable trend.

With regard to the afore-mentioned problem, IEEE 802.11 is a solution to realize the VOIP. The charge-free frequency band enables it to be popularized in a very short time, yet it still suffers from the shortcomings of high power consumption and short communication distance. Another solution to realize the VOIP is IEEE 802.16, wherein the charge-paid frequency band is utilized, yet it directly affects the competitiveness of the existing mobile phone business.

### SUMMARY

In view of the above-mentioned drawbacks and shortcomings of the prior art, the objective of the invention is to provide a system and method for realizing a Voice Over Internet Protocol (VOIP) by means of a Digital Enhanced Cordless Telecommunication (DECT). Thus, the VOIP is realized through the DECT. The seamless handoff between intradomain and interdomain, and roamings in intradomain and interdomain are achieved via a plurality of Mobile Agents.

To solve the problems and shortcomings of the prior art, the invention provides a system of realizing the VOIP by means of the DECT includes a plurality of DECTs used to conduct voice communication through a network, a plurality of base stations (BS) used to transmit and receive a signal emitted from the DECT in its operation range, a plurality of mobile agents used to receive and process the signal from the related base station and then transmit the processed signal, or transmit the signal through the tunnel between the mobile agents and then transmit the processed signal, a network phone gateway used to receive the signals transmitted from the respective mobile agents, and a session initiation protocol (SIP) proxy used to receive the signal transmitted from the network phone gateway so that the SIP network phone loop is formed by the respective DECT through the registration and address link of a session initiation protocol.

It is an advantage of the invention that the VOIP is realized through the DECT, and the seamless handoff between intradomain and interdomain and roamings in intradomain and interdomain are achieved, thus reducing costs significantly.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given herein below for illustration only, and thus is not limitative of the present invention, wherein:

FIG. 1 is a block diagram of a system of realizing a Voice Over Internet Protocol by means of Digital Enhanced Cordless Telecommunication according to an embodiment of the invention;

FIG. 2 is a flowchart of the steps of the method for realizing a Voice Over Internet Protocol by means of Digital Enhanced Cordless Telecommunication according to an embodiment of the invention; and

FIG. 3 is a flowchart of the steps of the method for registering Digital Enhanced Cordless Telecommunication with a SIP proxy according to an embodiment of the invention.

### DETAILED DESCRIPTION

The purpose, construction, features, and functions of the invention can be appreciated and understood more thoroughly through the following detailed description with reference to the attached drawings.

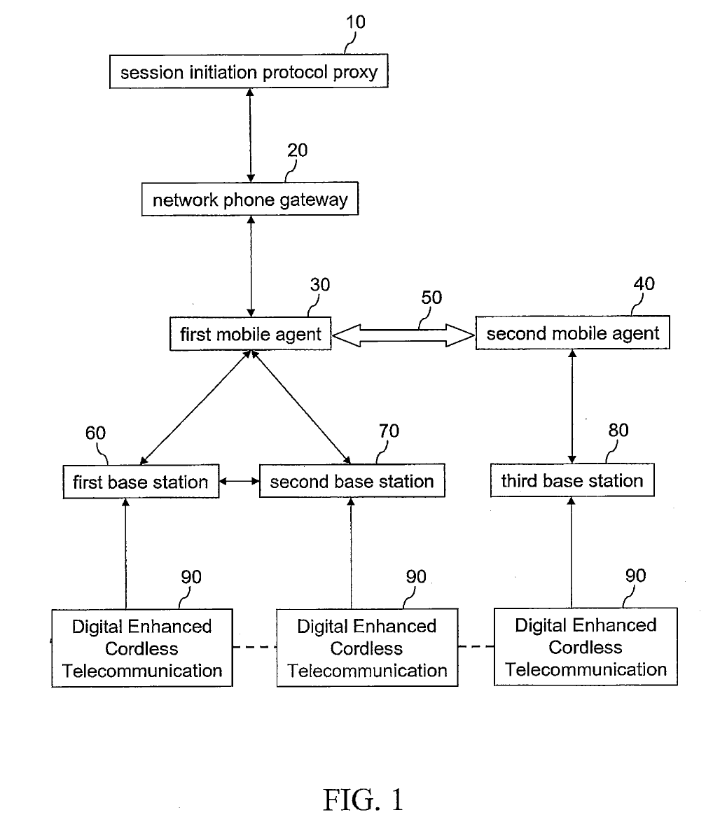

Firstly, refer to FIG. 1 of a block diagram of a system for realizing VOIP by means of a DECT according to an embodiment of the invention. As shown in FIG. 1, a VOIP is realized by means of the DECT, and the seamless handoff between intradomain and interdomain and roamings in intradomain and interdomain are achieved through a plurality of mobile agents. The system of the invention includes a DECT 90, a first base station 60, a second base station 70, a third base station 80, a first mobile agent 30, a second mobile agent 40, a tunnel 50, a network phone gateway 20, and a session initiation protocol (SIP) proxy 10.

When the DECT 90 is registered with a first base station 60, a session initiation protocol registration message is transmitted from a first base station 60 to a first mobile agent 30, which is used to transmit a SIP registration message to a SIP proxy 10. As such, the DECT 90 completes its SIP registration with the SIP proxy 10, and proceeds with the address linking with other DECT according to the registration information, hereby realizing voice communication.

When the DECT 90 is on-line, the calling signals or the RTP data packets are transmitted by the DECT 90 to a first mobile agent 30 through a first base station 60, and are processed by the first mobile agent 30, and then are transmitted to the SIP proxy 10 through the network phone gateway 20 for subsequent transmission to other DECT, requiring communication. For the SIP proxy 10, all the signals emitted by the DECT 90 are processed by the first mobile agent 30.

In case DECT 90 is making intra-domain roaming and is registered with the second base station 70, since at this time, the second base station 70 is still connected with the first mobile agent 30, the first mobile agent 30 is well aware of the position of the DECT 90, so the first mobile agent 30 redirects the calling signals or the RTP data packets directly, coming from the DECT 90. Subsequently, the calling signals or the RTP data packets are processed by the first mobile agent 30, then the processed calling signals or the RTP data packets are transmitted to the SIP proxy 10 through the network phone gateway 20.

In case DECT 90 is making inter-domain roamings, and is switching its registration to a third base station 80 of a second mobile agent 40, at this time a tunnel 50 is established from the first mobile agent 30 to the second mobile agent 40 by means of a communication mechanism. Then the calling signals or the RTP data packets are transmitted from the DECT 90 to the second mobile agent 40 through the third base station 80. The received calling signals or the RTP data packets are then transmitted from the second mobile agent 40 to the first mobile agent 30 through the tunnel 50. The calling signals or the RTP data packets thus received are processed by the first mobile agent 30, and then are transmitted to the SIP proxy 10 through the network phone gateway 20. When the communication of the DECT 90 terminates, then the tunnel 50 is disconnected.

Though the above-mentioned description, it is evident that, for both the intra-domain and the inter-domain roamings of the DECT 90, the signals emitted are all transmitted through the first mobile agent 30, thus realizing the seamless handoff between intradomain and interdomain, and roamings in intradomain and interdomain of the DECT 90.

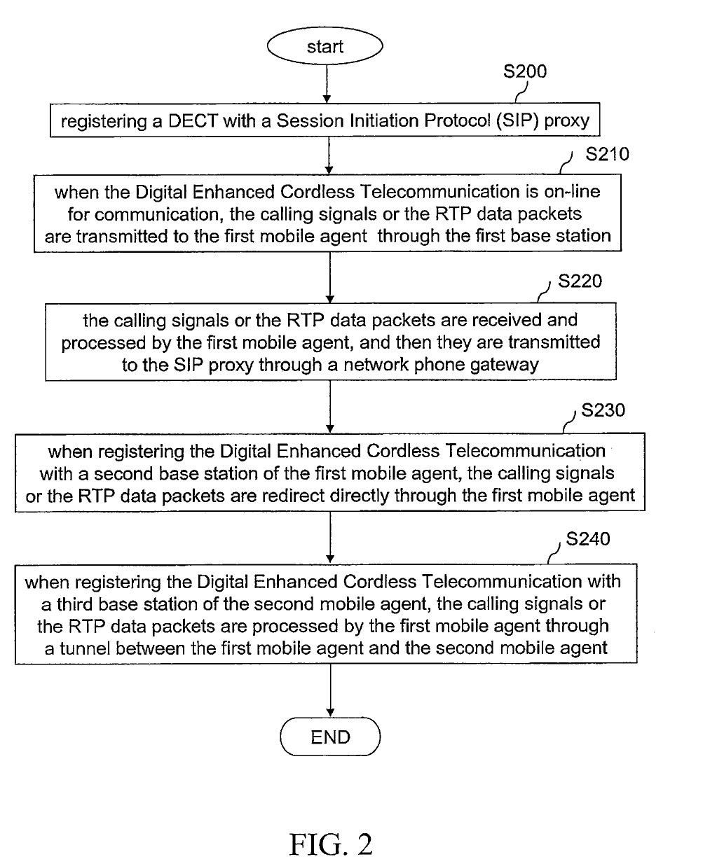

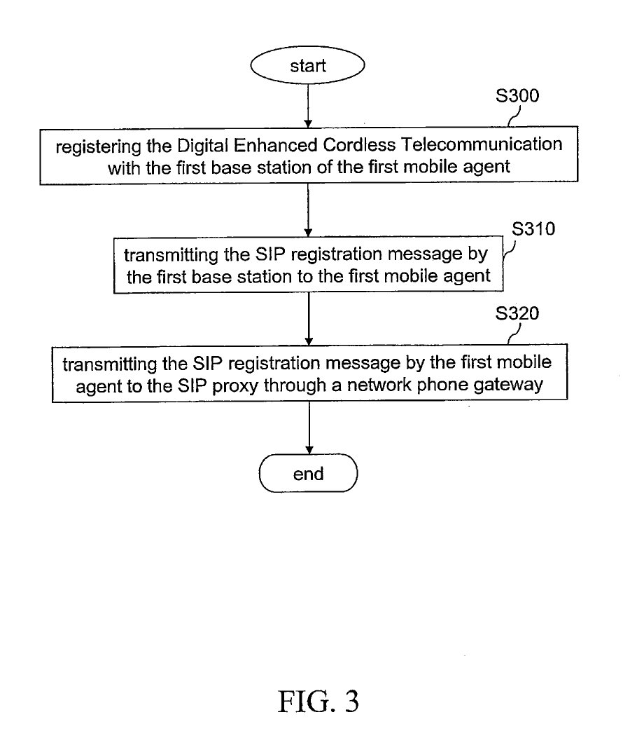

Next, refer to FIGS. 2 and 3. FIG. 2 is a flowchart of the steps of the method for realizing a Voice Over Internet Protocol (VOIP) by means of the DECT according to an embodiment of the invention. FIG. 3 is a flowchart of the steps of the method for registering the DECT 90 with a SIP proxy 10 according to an embodiment of the invention.

As shown in FIG. 2, the method of realizing the VOEP by means of the DECT of the invention includes the following steps.

Firstly, the step of registering DECT 90 to a SIP proxy 10 (step S200) has the following steps (as shown in FIG. 3). Initially, the DECT 90 is registered to a first base station 60 of a first mobile agent 30 (step S300). Next, a SIP registration message is transmitted from the first base station 60 to a first mobile agent 30 (step S310). Then, the SIP registration message is transmitted from the first mobile agent 30 to the SIP proxy 10 through a network phone gateway 20 (step S320). As such, the DECT 90 completes its SIP registration with the SIP proxy 10, and performs address linking with other DECT according to the registration information, to form the SIP network phone loop, thus enabling the realization of voice communication.

When the DECT 90 is on-line engaging in communication, the calling signals or the RTP data packets are transmitted from DECT 90 to the first mobile agent 30 through the first base station 60 (step S210), and are processed by the first mobile agent 30, and then are transmitted to the SIP proxy 10 through the network phone gateway 20 for subsequent transmission to other DECT requiring communication (step S220). For the SIP proxy 10, all the signals emitted by the DECT 90 are processed by the first mobile agent 30.

In case DECT 90 is making intra-domain roaming and is switching its registration to the second base station 70 of the first mobile station 30, the calling signals or the RTP data packets emitted by the DECT 90 are transmitted to the first mobile station 30 through the second base station 70, which is well aware of the present position of the DECT 90. As such, the first mobile agent 30 redirects directly the calling signals or the RTP data packets coming from the DECT 90. Subsequently, the calling signals or the RTP data packets are processed by the first mobile agent 30, and are transmitted to the SIP proxy 10 through the network phone gateway 20 (step S230).

In case DECT 90 is making inter-domain roaming, and is switching its registration to a third base station 80 of the second mobile agent 40, a tunnel 50 is established from the first mobile agent 30 to the second mobile agent 40 by means of a communication mechanism. The calling signals or the RTP data packets are transmitted from the DECT 90 to the second mobile agent 40 through a third base station 80. The received calling signals or the RTP data packets are transmitted from the second mobile agent 40 to the first mobile agent 30 through the tunnel 50. The calling signals or the RTP data packets thus received are processed by the first mobile agent 30, and then are transmitted to the SIP proxy 10 through a network phone gateway 20. When the communication of DECT 90 terminates, the tunnel 50 is disconnected (step 240).

Through the application of the above-mentioned system and the method of the invention, the DECT 90 may communicate with other DECT 90 through the network, hereby realizing the VOIP. For the DECT 90 roaming in an intra-domain or inter-domain manner, the signals emitted are all processed by a first mobile agent 30, thus realizing the seamless handoff between intradomain and interdomain, and roamings in intradomain and interdomain.

Knowing the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system for realizing a Voice Over Internet Protocol (VOIP) by means of a Digital Enhanced Cordless Telecommunication (DECT), wherein the VOIP is realized through the DECT, and a seamless handoff between intradomain and interdomain, and roamings in intradomain and interdomain are achieved through a plurality of mobile agents, comprising:
a plurality of DECTs used to conduct voice communication through network;
a plurality of base stations (BS) used to receive and transmit a signal emitted from the DECT;
a plurality of mobile agents used to receive and process the signal transmitted from the base stations and then transmit the processed signal, or transmit the processed signal through a tunnel between the mobile agents;
a network phone gateway, used to receive the signal transmitted from the mobile agents; and
a session initiation protocol (SIP) proxy, used to receive the signal transmitted from the network phone gateway, so that a SIP network phone loop is formed by each DECT through the registration and address link of session initiation protocol, thus enabling the realization of voice communications.

2. The system for realizing the VOIP by means of the DECT of claim 1, wherein the signal is a SIP registration message, a calling signal, or a real time transport protocol (RTP) data packet.

3. The system for realizing the VOIP by means of the DECT of claim 1, wherein the tunnel is established through the connection mechanism between each of the mobile agents.

4. The system for realizing the VOIP by means of the DECT of claim 1, wherein the tunnel is disconnected upon the termination of the communications of the DECT.

5. A method for realizing a Voice Over Internet Protocol (VOIP) by means of a Digital Enhanced Cordless Telecommunication (DECT), wherein the VOIP is realized through the DECT, and a seamless handoff between intradomain and interdomain, and roamings in intradomain and interdomain are achieved through a plurality of mobile agents, comprising the following steps:
registering a DECT with a Session Initiation Protocol (SIP) proxy;
transmitting calling signals or Real Time Transport (RTP) data packets to a first mobile agent through a first base station (BS), when the DECT being on-line for communication;
processing the received calling signals or the RTP data packets by the first mobile agent and then transmitting them to the SIP proxy through a network phone gateway;
redirecting the calling signals or the RTP data packets through the first mobile agent, when the DECT being registered with a second base station of the first mobile agent; and
processing the calling signals or the RTP data packets by the first mobile agent through a tunnel between the first mobile agent and the second mobile agent, when the DECT is registered with a third base station of a second mobile agent.

6. The method for realizing the VOIP by means of the DECT of claim 5, wherein the step of registering a DECT with a SIP proxy including the following steps:
registering the DECT with the first base station of the first mobile agent;
transmitting the SIP registration message by the first base station to the first mobile agent; and
transmitting the SIP registration message by the first mobile agent to the SIP proxy through the network phone gateway.

7. The method for realizing the VOIP by means of the DECT of claim 5, wherein the tunnel is established between the mobile agents through a connection mechanism.

8. The method for realizing the VOIP by means of the DECT of claim 5, wherein the tunnel is disconnected upon termination of the communications of the DECT.
